(19) United States
(12) Patent Application Publication
(10) Pub. No.: US 2016/0281204 A1
(43) Pub. Date: Sep. 29, 2016

(54) THERMAL BARRIER COATING REPAIR

(71) Applicant: UNITED TECHNOLOGIES CORPORATION, Hartford, CT (US)

(72) Inventor: Mark T. Ucasz, Middletown, CT (US)

(21) Appl. No.: 15/034,744

(22) PCT Filed: Oct. 27, 2014
(86) PCT No.: PCT/US14/62395

§ 371 Date: May 5, 2016

Related U.S. Application Data
(60) Provisional application No. 61/905,607, filed on Nov. 18, 2013.

(51) Int. Cl. C23C 4/134; F01D 5/28; F23R 3/00; F01D 11/08; F01D 25/30; C23C 4/06; F01D 9/02

(52) U.S. Cl. CPC C23C 4/134; C23C 4/06; F01D 5/288; F01D 9/02; F01D 11/08; F01D 25/30; F23R 3/002; F05D 2220/32; F05D 2230/13; F05D 2230/313; F05D 2230/312; F05D 2230/90; F05D 2300/6033; F05D 2300/177; F05D 2300/131

(57) ABSTRACT

A method of repairing a gas turbine engine component includes the steps of providing a component with a damaged thermal barrier coating surface, preparing the damaged thermal barrier coating surface to provide a repair area, and suspension plasma spraying a ceramic material onto the repair area to produce a repaired area.

### CROSS-REFERENCE TO RELATED APPLICATIONS

This application claims priority to U.S. Provisional Application No. 61/905,607, which was filed on Nov. 18, 2013 and is incorporated herein by reference.

### BACKGROUND

This disclosure relates to a repair process for components for applications such as gas turbine engines and internal combustion engines having a thermal barrier coating.

Many gas turbine engine components are subject to temperatures in excess of the melting temperature of the component substrate, which may be constructed from a nickel superalloy, for example. Cooling features and thermal barrier coatings are used to protect the substrate from these extreme temperatures.

During engine operation, thermal barrier coatings may become spalled, delaminated, chipped or eroded, for example, due to debris or environmental degradation. Any component with a damaged thermal barrier coating must either be replaced or repaired during maintenance of the engine.

Typically, the entire thermal barrier coating is removed from the component, for example, by grit blasting. If a bond coating is used, the bond coating may also be chemically removed to expose the substrate surface. Typically a bond coat is applied by low pressure plasma spray (LPPS), chemical vapor deposition (CVD) or cathodic arc, for example. Once the substrate surface is exposed, the thermal barrier coating may be reapplied, for example, by using an electron beam physical vapor deposition (EBPVD) process.

EBPVD applied coatings have a unique microstructure. The coatings are applied in a vacuum in an environment heated to approximately 2000° F. This EBPVD repair process takes considerable time and is costly.

### SUMMARY

In one exemplary embodiment, a method of repairing a gas turbine engine component, includes the steps of providing a component with a damaged thermal barrier coating surface, preparing the damaged thermal barrier coating surface to provide a repair area and suspension plasma spraying a ceramic material onto the repair area to produce a repaired area.

In a further embodiment of the above, the component is one of a vane, a blade, a blade outer air seal, a combustor liner, an exhaust liner, and an augmenter liner.

In a further embodiment of any of the above, the damaged thermal bather coating surface is at least one of spalled, eroded, delaminated, impact-damaged, or environmentally damaged.

In a further embodiment of any of the above, the providing step includes a component that has a substrate. The damaged thermal barrier coating surface is arranged on the substrate.

In a further embodiment of any of the above, the providing step includes a bond coat adhered to and between the substrate and the damaged thermal barrier coating surface.

In a further embodiment of any of the above, the substrate is at least one of a nickel based alloy, n iron-nickel based alloy cobalt based alloy, a molybdenum based alloy, or a niobium based alloy.

In a further embodiment of any of the above, the substrate is at least one of a ceramic based substrate or a ceramic matrix composite substrate.

In a further embodiment of any of the above, the bond coat is MCrAlY coating (where M is nickel, iron and/or cobalt), an aluminide coating, a platinum aluminide coating, or a ceramic-based coating.

In a further embodiment of any of the above, the damaged thermal barrier coating surface is at least one or more layers of an yttria stabilized zirconia material, a gadolinia stabilized zirconia material, cubic/fluorite/pyrochlore/delta phase fully stabilized zirconates where stabilizers are any oxide or mix of oxides including Lanthanide series, Y, Sc, Mg, Ca, or further modified with Ta, Nb, Ti, Hf.

In a further embodiment of any of the above, the preparing step includes removing some of the damaged thermal barrier coating.

In a further embodiment of any of the above, the preparing step includes removing some of the damaged thermal barrier coating by grit blasting, water jet, or laser removal. (Ceramic coating removal not limited to grit blast but could also include other methods such as, etc).

In a further embodiment of any of the above, the damaged thermal bather coating is removed down to a bond coat adhered to a substrate.

In a further embodiment of any of the above, the damaged thermal bather coating is a ceramic coating formed by one of an electron beam physical vapor deposition process, a suspension plasma spray process or an air plasma spray process.

In a further embodiment of any of the above, the suspension plasma spraying step produced columnar ceramic microstructure substantially similar to an adjacent undamaged thermal barrier coating.

In a further embodiment of any of the above, the adjacent undamaged thermal barrier coating is a ceramic coating formed by an electron beam physical vapor deposition process, a suspension plasma spray process or an air plasma spray process.

In a further embodiment of any of the above, the method includes the step of leveling the repaired area relative to a surrounding thermal barrier coating.

In a further embodiment of any of the above, the leveling step includes sanding the repaired area flush with the surrounding thermal bather coating.

In a further embodiment of any of the above, the leveling step produces a finished exterior airfoil surface.

In another exemplary embodiment, a method of repairing a gas turbine engine component, includes the steps of providing a component with a damaged thermal barrier coating surface, preparing the damaged thermal barrier coating surface to provide a repair area, suspension plasma spraying a ceramic material onto the repair area to produce a repaired area, and leveling the repaired area relative to a surrounding thermal barrier coating.

In another exemplary embodiment, a gas turbine engine component includes a substrate, a bond coat adhered to the substrate, and a thermal barrier coating adhered to the bond coat. The thermal barrier coating includes an undamaged thermal barrier coating applied by a first process and that is adjacent a repaired area applied by a second process that is different than the first process. The second process provides a ceramic microstructure substantially similar to the undamaged thermal barrier coating.

### BRIEF DESCRIPTION OF THE DRAWINGS

The disclosure can be further understood by reference to the following detailed description when considered in connection with the accompanying drawings wherein:

FIGS. 1A-1D schematically depicts a damaged thermal barrier coating surface and a process for repairing same.

FIG. 2 is a flow chart depicting an example method of repairing a damaged thermal barrier coating.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

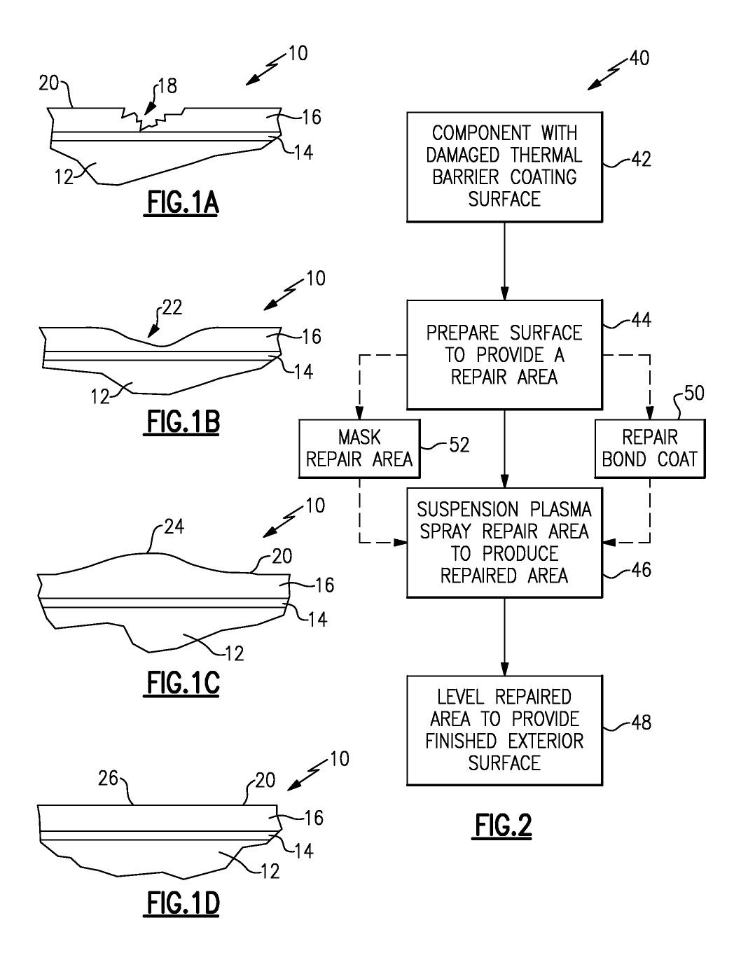

A component 10 having a thermal barrier coating 16 is schematically shown in FIG. 1A. A disclosed method 40 of repair of the thermal barrier coating 16 is shown in FIG. 2 and schematically represented in FIGS. 1B-1D.

The component 10, which may be a turbine blade airfoil, for example, includes a substrate 12. The disclosed repair method can be used for a variety of gas turbine engine components, including but not limited to vanes, blades, blade outer air seals, combustor liners, exhaust liners, and augmenter liners. Internal combustion engine components, such as exhaust manifolds, intake manifolds, headers, turbo chargers, external waste gates, exhaust down pipes, exhaust systems, converters and mufflers, could also have their coatings repaired by the disclosed method. The substrate 12 may be formed from any suitable material, such as a nickel based alloy, an iron-nickel based alloy, a cobalt based alloy, a molybdenum based alloy, or a niobium based alloy. Alternatively, substrate 12 may be a ceramic based substrate or a ceramic matrix composite substrate.

The thermal barrier coating 16 may be adhered directly to the substrate 12 or, as in the example illustrated in FIGS. 1A-1D, a bond coat 14 may be provided between and adhered to the substrate 12 and the thermal barrier coating 16.

The bond coat 14 may be either a MCrAlY coating (where M is nickel, iron and/or cobalt), an aluminide coating, a platinum aluminide coating, or a ceramic-based bond coat. The bond coat may be applied using any suitable technique known in the art. NiCoCrAlY bond coat and an yttria-stabilized zirconia (YSZ) thermal bather coating may be used to provide the disclosed bond coat 14 and thermal barrier coating 16, for example. Of course, numerous other ceramic layers may be used. MCrAlY coatings also include MCrAlYX coatings, where X is at least one of a reactive element (Hf, Zr, Ce, La, Si) and/or refractory element (Ta, Re, W, Nb, Mo).

The thermal bather coating 14 may comprise one or more layers of a ceramic material such as an yttria stabilized zirconia material, a gadolinia stabilized zirconia material, cubic/fluorite/pyrochlore/delta phase fully stabilized zirconates where stabilizers are any oxide or mix of oxides including Lanthanide series, Y, Sc, Mg, Ca, or further modified with Ta, Nb, Ti, Hf. The yttria stabilized zirconia material may contain from 3.0 to 40 wt. % yttria and the balance zirconia. The gadolinia stabilized zirconia material may contain from 5.0 to 99.9 wt. % gadolinia, and in one example, 30 to 70 wt. % gadolinia and the balance zirconia.

The thermal barrier coating 16 has an exterior surface 20. In the example illustrated, the thermal barrier coating 16 is the outermost layer of the component 10. Additional layers may be provided on the thermal barrier coating 16 covering the exterior surface 20, if desired.

The thermal barrier coating 16 includes a damaged thermal barrier coating surface 18, which may result from oxidation, corrosion, spallation, delamination, erosion, environmental attack/damage from contaminants (fuel, ambient air contaminants, pollutants, etc) or foreign object impact, for example (block 42, FIG. 2). Damage may also occur during the manufacturing process.

The component 10 is prepared for a repair by preparing the damaged thermal barrier coating surface 20 to provide a repair area 22, as illustrated in FIG. 1B (block 44, FIG. 2). The repair area may be provided by mechanical stripping, such as by a grit blasting, water jet or laser removal of coating from the damaged area. In one aspect the repair area 22 depth is limited so any bond coat 14 is not exposed. In another aspect a portion of the repair area 22 depth extends to the bond coat 14, such that the bond coat is also repaired (block 50, FIG. 2). The surface of the repair area 22 is shown as sloped, although transition to the repair area could be more abrupt, for example, perpendicular to the surrounding undamaged TBC.

In the example, the original thermal barrier coating 16 is provided by applying a ceramic material using an electron beam physical vapor deposition (EBPVD), a suspension plasma spray (SPS), sputtering, sol gel, slurry, low pressure plasma spray (LPPS) or air plasma spray (APS), for example. Each of these application processes provides a unique microstructure to the ceramic thermal barrier coating layer.

In the example, the repair area is repaired by suspension plasma spraying a ceramic material onto the repair area 22 to produce a repaired area 24, as shown in FIG. 1C (block 46, FIG. 2). Relative to for example, an EBPVD deposited original thermal barrier coating 16, the SPS columnar microstructure may have different column structure/microstructure. The SPS coating in the repaired area 24 will be polycrystalline, typically free of distinct lamellar features common in prior art plasma spray coatings. The SPS coating in the repaired area 24 is characterized by columns separated by vertical cracks or defined gaps (e.g., the column diameter is such that the coating is characterized by greater than 100 gaps per inch (40 gaps/cm), more narrowly>80 gaps/cm or 80-160 gaps/cm (characteristic “diameters” being the inverse thereof)). In contrast, a typical EBPVD coating has characteristic single crystal columns with a determined crystallographic texture with individual column diameters of about 10-20 micrometers.

Despite providing a different ceramic microstructure from the suspension plasma spray process in the repaired area 24 as compared to, for example, the electron beam physical vapor deposition process that formed the original thermal barrier coating 16, the microstructures are sufficiently similar to produce a durable repair for use in gas turbine engines. Suspension plasma spraying may be desirable to conventional plasma spraying in that smaller particles can be used in the feedstock that enable the formation of fine columns separated by vertical gaps or microcracks providing strain tolerance to the coating during thermal cycling. In conventional plasma spraying, solid particles in the size range of about 10 microns to about 100 microns are used to produce laminar microstructures containing lamellae or splats with diameters of about 10 to about a few hundred microns and thicknesses of from about 1 micron to about 5 microns. Feedstock particle sizes in suspension plasma spraying are nominally less than about 1 micron. Particles of this size cannot be deposited by conventional plasma spray processes because current dry particle feeders are insufficient to entrain the fine particles into the fast moving gas stream. A liquid carrier is required to hold the fine particles in suspension and provide the mass sufficient to inject and entrain the particles into the fast moving gas stream.

Additionally, suspension plasma spray is applied at lower temperatures than EBPVD, which is desirable. Attempting to use an EBPVD process for repair would warp any masks that might be used during the repair process due to thermal stresses introduced by the process. EBPVD masks would be costly to manufacture and impractical as each defective area would be different. If a repair to a small area was required using EBPVD, it is more efficient to repair the entire ceramic coating as the time spent in the EBPVD coater would be the same time. The disclosed SPS repair process may use masking to eliminate or minimize overspray (block 52, FIG. 2). Masking for repaired parts may be desirable, however, using an SPS coater with a small coating plume could eliminate the mask.

The repaired area 24 may then be leveled relative to a surrounding thermal barrier coating surface 20 so that the repaired area is flush, as indicated at 26 in FIG. 1D (block 48, FIG. 2). The leveling may be done by sanding the repaired area 24 to produce a finished exterior airfoil surface, for example.

The repair method enables faster repairs as full coating removal is not necessary. Moreover, there is no loss of substrate wall thickness as each removal of bond coat, as is typical in the prior art, reduces substrate wall thickness and thus reduces hardware life if limited by wall thickness (for example, thin wall HPT blades).

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of repairing a gas turbine engine component, comprising the steps of:
providing a component with a damaged thermal barrier coating surface;
preparing the damaged thermal barrier coating surface to provide a repair area; and
suspension plasma spraying a ceramic material onto the repair area to produce a repaired area.

2. The method according to claim 1, wherein the component is one of a vane, a blade, a blade outer air seal, a combustor liner, an exhaust liner, and an augmenter liner.

3. The method according to claim 1, wherein the damaged thermal barrier coating surface is at least one of spalled, eroded, delaminated, impact-damaged, or environmentally damaged.

4. The method according to claim 1, wherein the providing step includes a component having a substrate, and the damaged thermal barrier coating surface is arranged on the substrate.

5. The method according to claim 4, wherein providing step includes a bond coat adhered to and between the substrate and the damaged thermal barrier coating surface.

6. The method according to claim 5, wherein the substrate is at least one of a nickel based alloy, an iron-nickel based alloy, a cobalt based alloy, a molybdenum based alloy, or a niobium based alloy.

7. The method according to claim 5, wherein the substrate is at least one of a ceramic based substrate or a ceramic matrix composite substrate.

8. The method according to claim 5, wherein the bond coat is MCrAlY coating (where M is nickel and/or cobalt), an aluminide coating, a platinum aluminide coating, or a ceramic-based coating.

9. The method according to claim 5, wherein the damaged thermal barrier coating surface is at least one or more layers of an yttria stabilized zirconia material, a gadolinia stabilized zirconia material, cubic/fluorite/pyrochlore/delta phase fully stabilized zirconates where stabilizers are any oxide or mix of oxides including Lanthanide series, Y, Sc, Mg, Ca, or further modified with Ta, Nb, Ti, Hf.

10. The method according to claim 1, wherein the preparing step includes removing some of the damaged thermal barrier coating by grit blasting, water jet, or laser removal.

11. The method according to claim 10, wherein the preparing step includes grit blasting some of the damaged thermal barrier coating.

12. The method according to claim 10, wherein the damaged thermal barrier coating is removed down to a bond coat adhered to a substrate.

13. The method according to claim 1, wherein the damaged thermal barrier coating is a ceramic coating formed by one of an electron beam physical vapor deposition process, a suspension plasma spray process, sputtering, sol gel, slurry, low pressure plasma spray, or an air plasma spray process.

14. The method according to claim 1, wherein the suspension plasma spraying step produced columnar ceramic microstructure substantially similar to an adjacent undamaged thermal barrier coating.

15. The method according to claim 14, wherein the adjacent undamaged thermal barrier coating is a ceramic coating formed by an electron beam physical vapor deposition process, a suspension plasma spray process or an air plasma spray process.

16. The method according to claim 1, comprising the step of leveling the repaired area relative to a surrounding thermal barrier coating.

17. The method according to claim 16, wherein the leveling step includes sanding the repaired area flush with the surrounding thermal barrier coating.

18. The method according to claim 17, wherein the leveling step produces a finished exterior airfoil surface.

19. A method of repairing a gas turbine engine component, comprising the steps of:
providing a component with a damaged thermal barrier coating surface;
preparing the damaged thermal barrier coating surface to provide a repair area;
suspension plasma spraying a ceramic material onto the repair area to produce a repaired area; and
leveling the repaired area relative to a surrounding thermal barrier coating.

20. A gas turbine engine component comprising:
a substrate;
a bond coat adhered to the substrate; and
a thermal barrier coating adhered to the bond coat, the thermal barrier coating including an undamaged thermal barrier coating applied by a first process and that is adjacent a repaired area applied by a second process that is different than the first process, the second process providing a ceramic microstructure substantially similar to the undamaged thermal barrier coating.
